(19) United States
(12) Patent Application Publication
(10) Pub. No.: US 2023/0114823 A1
(43) Pub. Date: Apr. 13, 2023

(54) METHOD FOR PRODUCING COATED OPTICAL FIBER AND COATED OPTICAL FIBER PRODUCTION APPARATUS

(71) Applicant: NITTO DENKO CORPORATION, Osaka (JP)

(72) Inventors: Kenjiro SAOMOTO, Osaka (JP); Tatsuya ARAKI, Osaka (JP); Yuki FUJIWARA, Osaka (JP); Hajime MICHIHIRA, Osaka (JP)

(73) Assignee: NITTO DENKO CORPORATION, Osaka (JP)

(21) Appl. No.: 17/911,325

(22) PCT Filed: Mar. 16, 2021
(86) PCT No.: PCT/JP2021/010555

§ 371 Date: Sep. 13, 2022

(30) Foreign Application Priority Data
Mar. 18, 2020 (JP) 2020-048400

(51) Int. Cl. C03C 25/16; C03C 25/106

(52) U.S. Cl. CPC C03C 25/16; C03C 25/106

(57) ABSTRACT

A method for producing a coated optical fiber includes coating, using a coating die, a circumferential side surface of an optical fiber with a coating material by passing the optical fiber sequentially through an insertion hole portion, a_ liquid retaining chamber (21), and a_coating hole portion opposed to the insertion hole portion, while the coating material in the liquid retaining chamber is supplied under pressure to the coating hole portion, in which a pressure difference ΔP (MPa) between a liquid pressure of the coating material in the liquid retaining chamber and a pressure outside the coating die, a viscosity µ (Pa·s) of the coating material in the liquid retaining chamber, and a length L (mm) of the coating hole portion in an extending direction satisfy a relationship of ΔP/µL ≤ 0.15.

### TECHNICAL FIELD

The present invention relates to a method for producing a coated optical fiber, and a coated optical fiber production apparatus used for the same.

### BACKGROUND ART

Optical fibers usually have a form in which a coating film on the circumferential side surface of an optical fiber wire is formed. The coating film of the optical fiber is required to ensure, for example, optical transmission characteristics, mechanical characteristics, weather resistance, or the like. The technique relating to the coating film forming on the optical fiber is disclosed in, for example, Patent Document 1 below.

### Citation List

### Patent Document

Patent Document 1: Japanese Unexamined Patent Publication No. 2006-3720

### SUMMARY OF THE INVENTION

### Problem to Be Solved by the Invention

To form the coating film of the optical fiber, for example, a coating die is used having the following configuration. The coating die includes an inner space filled with a coating material in liquid state, a minute-diameter fiber insertion path, and a minute-diameter fiber drawing path, where the paths communicate with the inner space and are opposed to each other with such space interposed therebetween. In this coating die, an optical fiber wire is sequentially passed through the fiber insertion path, the inner space (filled with the coating material in liquid state), and the fiber drawing path, thereby coating the circumferential side surface of the optical fiber wire with the coating material. The coated film is then, for example, dried to form a coating film on the optical fiber. Such formation of the coating film in this manner conventionally causes variations in film thickness along the optical fiber extending direction. In the coating material that passes through the minute-diameter fiber drawing path together with the optical fiber wire, a minute turbulent flow caused around the fiber and a pressure difference between both opening ends of the fiber drawing path (pressure difference between the inside and outside of the coating die) are combined to generate slight pulsations in the flow direction of the coating material, which may cause the above-mentioned variations in film thickness.

On the other hand, the optical fiber is required to have small variations in thickness along its extending direction. That is, the coating film of the optical fiber is required to have small variations in thickness along the fiber extending direction. When the optical fiber has large variations in thickness, some cut portions of the optical fiber have excessively larger or smaller cross-section dimensions than a prescribed size, so that the cut portion of the optical fiber may not be suitably connected to an optical connector having a fiber insertion port corresponding to the prescribed size.

The present invention is to provide a method for producing a coated optical fiber suitable for suppressing variations in film thickness along the fiber extending direction, and a coated optical fiber production apparatus used for the same.

### Means for Solving the Problem

The present invention [1] includes a method for producing a coated optical fiber using a coating die including a liquid retaining chamber that receives a coating material in liquid state; an insertion hole portion that communicates with the liquid retaining chamber; and a coating hole portion that communicates with the liquid retaining chamber, the coating hole portion being opposed to the insertion hole portion via the liquid retaining chamber and extending in a direction away from the liquid retaining chamber, the method including coating a circumferential side surface of an optical fiber with the coating material by, in the coating die, passing the optical fiber sequentially through the insertion hole portion, the liquid retaining chamber, and the coating hole portion while the coating material in the liquid retaining chamber is supplied under pressure to the coating hole portion, in which a pressure difference ΔP (MPa) between a liquid pressure of the coating material in the liquid retaining chamber and a pressure outside the coating die, a viscosity µ (Pa·s) of the coating material in the liquid retaining chamber, and a length L (mm) of the coating hole portion in an extending direction satisfy a relationship of ΔP/µL ≤ 0.15.

In this production method, as mentioned above, in the state where the pressure difference ΔP (MPa) between the liquid pressure of the coating material in the liquid retaining chamber and the pressure outside the coating die, the viscosity µ (Pa·s) of the coating material, and the length L (mm) of the coating hole portion in the extending direction satisfy the conditional equation of ΔP/µL ≤ 0.15, while the coating material in the liquid retaining chamber is supplied under pressure to the coating hole portion, the optical fiber is passed sequentially through the insertion hole portion, the liquid retaining chamber, and the coating hole portion, thereby coating the circumferential side surface of the optical fiber with the coating material. This configuration is suitable for suppressing variations in thickness of the coating film along the fiber extending direction, where the coating film is formed by coating the circumferential side surface of the optical fiber with the coating material.

The present invention [2] includes the method for producing a coated optical fiber described in [1], in which the length L is 1.5 mm or more.

This configuration is suitable for reducing the effect of the above-mentioned pressure difference ΔP (a factor in which a larger pressure difference is likely to induce the above-described pulsations of the coating material) on the coating material that passes through the coating hole portion together with the optical fiber, and is therefore suitable for suppressing the pulsations of the coating material that passes through the coating hole portion to thereby suppress the above-described variations in film thickness of the optical fiber.

The present invention [3] includes the method for producing a coated optical fiber described in [1] or [2], in which the viscosity µ is 0.3 Pa·s or more.

This configuration is suitable for reducing the effect of the above-mentioned pressure difference ΔP on the coating material that passes through the coating hole portion together with the optical fiber, and is therefore suitable for suppressing the pulsations of the coating material that passes through the coating hole portion to thereby suppress the above-described variations in film thickness of the optical fiber.

The present invention [4] includes the method for producing a coated optical fiber described in any one of the above-described [1] to [3], in which the pressure difference ΔP is 0.3 MPa or less.

This configuration is suitable for suppressing the pulsations of the coating material that passes through the coating hole portion together with the optical fiber, and is therefore suitable for suppressing the above-described variations in film thickness of the optical fiber.

The present invention [5] includes the method for producing a coated optical fiber described in any one of the above-described [1] to [4], in which the coating material is an ultraviolet curing resin.

This configuration is suitable for achieving high adhesion to the fiber and high durability of the coating film formed on the circumferential side surface of the optical fiber, and is also suitable for achieving high productivity of the produced coated optical fiber.

The present invention [6] includes a coated optical fiber production apparatus for performing the method for producing a coated optical fiber described in any one of the above-described [1] to [5], the apparatus including a coating die having a liquid retaining chamber for receiving a coating material in liquid state; an insertion hole portion that communicates with the liquid retaining chamber; and a coating hole portion that communicates with the liquid retaining chamber, the coating hole portion being opposed to the insertion hole portion via the liquid retaining chamber and extending in a direction away from the liquid retaining chamber.

This coated optical fiber production apparatus can suitably perform the above-described method for producing an optical fiber.

The present invention [7] includes the coated optical fiber production apparatus described in [6], in which the coating hole portion has a length L in an extending direction of 1.5 mm or more.

This configuration is suitable for reducing the effect of the above-mentioned pressure difference ΔP on the coating material that passes through the coating hole portion together with the optical fiber during use of the apparatus, and is therefore suitable for suppressing the above-described pulsations of the coating material to thereby suppress the above-described variations in film thickness of the optical fiber.

### BRIEF DESCRIPTION OF THE DRAWINGS

FIG. 1 is a configurational diagram of a coated optical fiber production apparatus for performing a method for producing an optical fiber according to an embodiment of the present invention.

FIG. 2 is a perspective view of a coating die provided in the coated optical fiber production apparatus shown in FIG. 1.

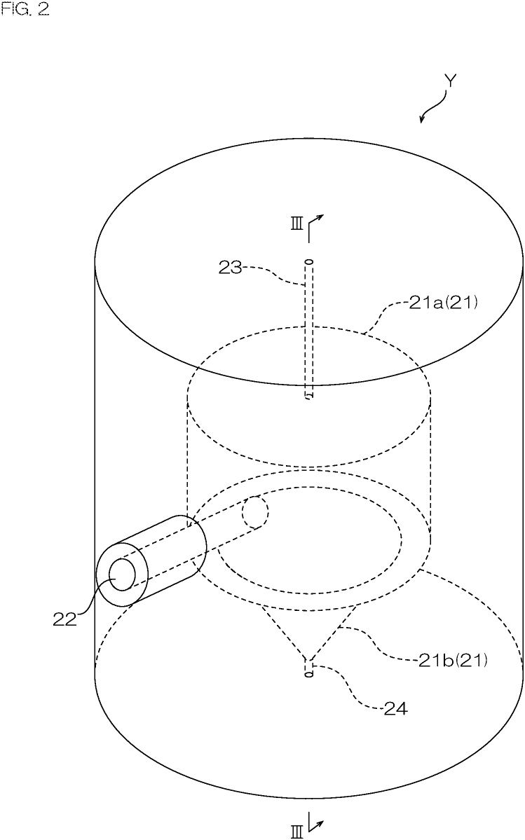

FIG. 3 is a cross-sectional view of the coating die shown in FIG. 2, taken along line III-III.

FIG. 4 is a partially enlarged cross-sectional view of the coating die shown in FIGS. 2 and 3.

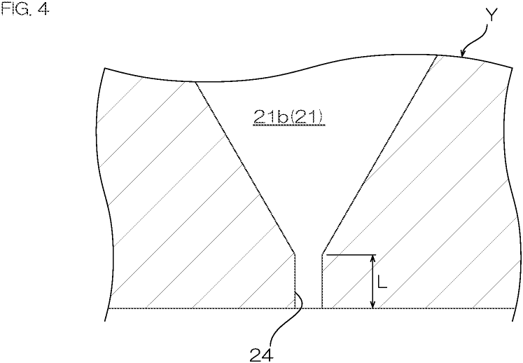

FIG. 5 illustrates coating in the coating die according to the present invention.

FIG. 6 is a cross-sectional view of an example of an optical fiber having a coating film.

### DESCRIPTION OF THE EMBODIMENTS

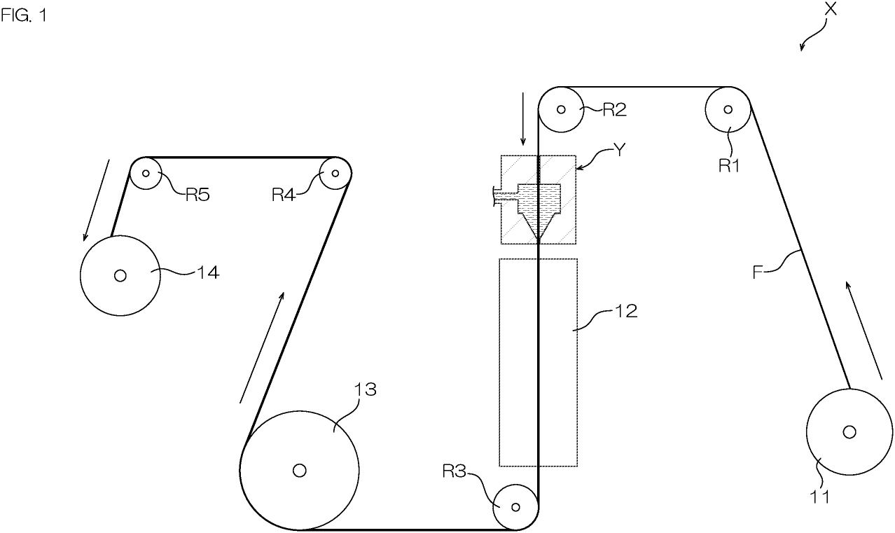

FIG. 1 shows a coated optical fiber production apparatus X according to an embodiment of the present invention. The coated optical fiber production apparatus X is an apparatus to be used for the method for producing a coated optical fiber according to an embodiment of the present invention, and includes a feeding unit 11, a coating die Y, a curing unit 12, a capstan 13, and a winding unit 14 sequentially in an optical fiber traveling direction. FIG. 1 also shows an optical fiber F traveling from the feeding unit 11 to the winding unit 14 in the coated optical fiber production apparatus X (the optical fiber traveling direction is indicated by arrows).

The feeding unit 11 is a part that supplies the optical fiber F to be film-formed into a process in the apparatus and is, for example, a reel (optical fiber reel) with the optical fiber F wound thereon and rotatably provided around a predetermined axis. The optical fiber F may be an optical fiber wire or an optical fiber core wire. The optical fiber F is a plastic optical fiber or a glass optical fiber, and in the present embodiment, a plastic optical fiber is preferably used.

The optical fiber F as a plastic optical fiber includes a core having a relatively high refractive index and serving as an optical transmission line itself, and a clad having a relatively low refractive index and positioned around the core to extend along the core. Examples of a constituent material of the core include an acrylic polymer such as polymethyl methacrylate, and a fluorine-containing polymer such as fluorine-containing polyimide. To the constituent material of the core may be added a low-molecular material (dopant) for adjusting the refractive index to a high value. Examples of a constituent material of the clad include an acrylic polymer such as polymethyl methacrylate, a polycarbonate, and a fluorine-containing polymer such as fluorine-containing polyimide.

The optical fiber F has a thickness, that is, a cross-sectional diameter of, for example, 100 to 1000 µm when it is an optical fiber wire, and for example, 25 to 500 µm when it is an optical fiber core wire.

The coating die Y is, for example, a metal die for coating a surface, specifically, a circumferential side surface of the optical fiber F with a coating material, and has a liquid retaining chamber 21, a coating material supply port 22, an insertion hole portion 23, and a coating hole portion 24. The coating die Y is also constituted such that the temperature inside the die can be controlled by a temperature control mechanism (not illustrated).

The liquid retaining chamber 21 is a chamber, or space, in the coating die Y for receiving a coating material in liquid state. In the present embodiment, the liquid retaining chamber 21 includes a cylindrical space 21a and a truncated conical space 21b. The bottom face of the truncated conical space 21b has a smaller diameter than that of the cylindrical space 21a, and the cylindrical space 21a and the truncated conical space 21b are continuously arranged to have a common axis of rotational symmetry Ax (that is, the liquid retaining chamber 21 is a space shaped to have the axis of rotational symmetry Ax). The cylindrical space 21a has a diameter D1 of, for example, 3 to 50 mm, and a height D2 of, for example, 5 to 100 mm. The truncated conical space 21b has a diameter D3 of, for example, 2 to 50 mm at the bottom face thereof, and a height D4 of, for example, 1 to 20 mm. An opening angle θ formed between opposed generating lines, conical generatrices, in the truncated conical space 21b is, for example, from 5 to 90 degrees. The coating die Y is installed in such a posture that in the liquid retaining chamber 21, the cylindrical space 21a is located at a relatively upper position and the truncated conical space 21b is located at a relatively lower position (preferably, in such a posture that the axis of rotational symmetry Ax of the liquid retaining chamber 21 extends in a vertical direction).

The coating material supply port 22 is a flow channel for supplying a coating material in liquid state from outside of the coating die Y to the liquid retaining chamber 21, and communicates with the cylindrical space 21a of the liquid retaining chamber 21. The coating material supply port 22 extends in a radial direction of the cylindrical space 21a, and one end thereof is open in an outer surface of a side wall of the coating die Y, while the other end thereof is open in an inner surface of a side wall of the cylindrical space 21a. The coating material supply port 22 has a diameter of, for example, 1 to 20 mm. The coating material supply port 22 is in connection with a tank (not illustrated) for storing the coating material in liquid state with a predetermined tube member (not illustrated) such as a flexible tube interposed therebetween. To the tank or the tube member is attached a pressure-supply means (not illustrated) such as a pump capable of delivering the coating material in the tank toward the liquid retaining chamber 21 of the coating die Y and of controlling the supply pressure of the coating material.

Examples of the coating material include an ultraviolet curing resin composition and a thermosetting resin composition. From a viewpoint of achieving high adhesion to the fiber and high durability of the film formed on the circumferential side surface of the optical fiber, an ultraviolet curing resin composition is preferably used as the coating material. Examples of the resin in the resin composition include urethane acrylate resin, polyester acrylate resin, epoxy acrylate resin, polyol acrylate resin, epoxy resin, silicone resin, nylon resin, and polyamide resin.

The coating material may contain a coloring component such as pigment and dye. Examples of the pigment include black pigment such as carbon black; white pigment such as titanium oxide and zinc oxide; red pigment such as iron oxide; yellow pigment such as yellow lead or chrome yellow, and zinc chromate; blue pigment such as ultramarine blue and cobalt blue; and green pigment such as chromium oxide.

The insertion hole portion 23 is a hole for inserting the optical fiber F toward the liquid retaining chamber 21 from outside of the coating die Y, and communicates with the cylindrical space 21a of the liquid retaining chamber 21. The insertion hole portion 23 extends along the axis of rotational symmetry Ax, and one end thereof is open in an outer surface of an upper wall of the coating die Y, while the other end thereof is open in an inner surface of an upper wall of the cylindrical space 21a. The diameter of the insertion hole portion 23 is set according to the diameter of the optical fiber F and is, for example, 5 to 500 µm larger than that of the optical fiber F. The insertion hole portion 23 also has a length in the extending direction of, for example, 1 to 50 mm.

The coating hole portion 24 is a hole for letting the optical fiber F through from the liquid retaining chamber 21 to outside of the coating die Y, and communicates with the truncated conical space 21b of the liquid retaining chamber 21. The coating hole portion 24 extends along the axis of rotational symmetry Ax, and one end thereof is open at the top of the truncated conical space 21b, while the other end thereof is open in an outer surface of a lower wall of the coating die Y. The coating hole portion 24 is opposed to the insertion hole portion 23 with the liquid retaining chamber 21 interposed therebetween, and extends in a direction away from the liquid retaining chamber 21. The coating hole portion 24 extends from the liquid retaining chamber 21 to the opposite side of the insertion hole portion 23.

The diameter of the coating hole portion 24 is set according to the sum of the diameter of the optical fiber F and the thickness of a coating film to be formed, and is, for example, 10 to 2000 µm larger than that of the optical fiber F.

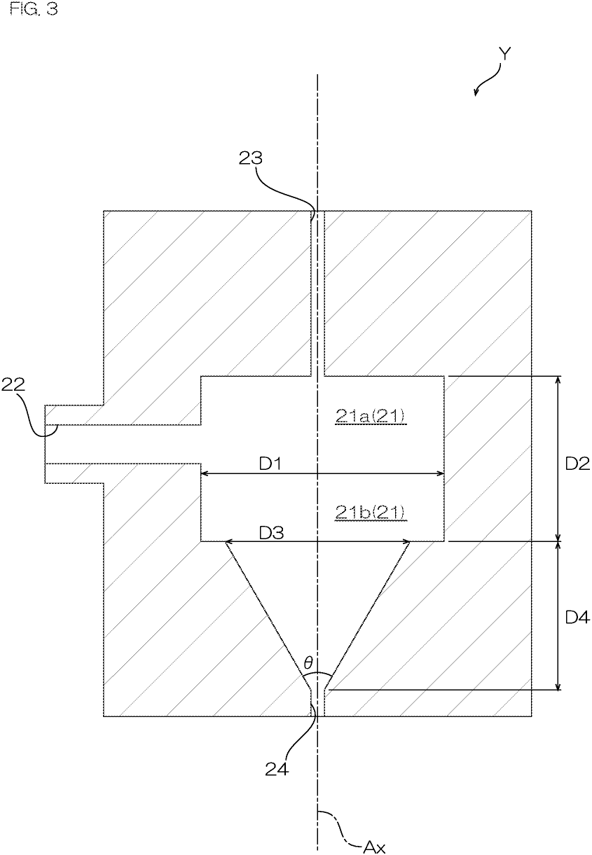

The coating hole portion 24 has a length L (shown in FIG. 3) in the extending direction of preferably 1.5 mm or more, more preferably 2 mm or more, more preferably 3 mm or more, more preferably 3.5 mm or more, more preferably 4 mm or more.

The length L of the coating hole portion 24 in the extending direction is, for example, 30 mm or less, preferably 20 mm or less. This configuration is preferable from viewpoints of accuracy of machining of the coating hole portion 24 in the production process of the coating die Y, ease of cleaning of the coating hole portion 24 during non-use of the coating die Y, and ease of work for allowing the optical fiber F to pass through the coating hole portion 24 of the coating die Y at the time of starting the method for producing a coated optical fiber in the coated optical fiber production apparatus X.

The curing unit 12 is a part that cures the coating material applied to the optical fiber F that has passed through the coating die Y. When an ultraviolet curing resin composition is used as the coating material, the curing unit 12 is, for example, an ultraviolet irradiation device such as an UV lamp. When a thermosetting resin composition is used as the coating material, the curing unit 12 is, for example, a heating furnace.

The capstan 13 is a part that draws the optical fiber F from the feeding unit 11 by rotary drive to control a linear speed, that is, a traveling speed of the optical fiber F.

The winding unit 14 is a part that winds up the optical fiber F.

In the present embodiment, guide rollers R1 and R2 are provided for guiding the optical fiber F between the feeding unit 11 and the coating die Y, a guide roller R3 is provided for guiding the optical fiber F between the coating die Y and the capstan 13, and guide rollers R4 and R5 are provided for guiding the optical fiber F between the capstan 13 and the winding unit 14. The number of guide rollers and their arrangement locations are appropriately determined according to the sizes, arrangement locations, and the like of the feeding unit 11, the coating die Y, the curing unit 12, the capstan 13, and the winding unit 14.

The method for producing a coated optical fiber according to an embodiment of the present invention is performed using the coated optical fiber production apparatus X having the coating die Y and the like as described above. Specific details are as follows.

In this production method, the optical fiber F travels from the feeding unit 11 to the winding unit 14 while the optical fiber F is fed from the feeding unit 11 and wound up by the winding unit 14. The traveling speed is controlled by the capstan 13 that draws the optical fiber F by the rotary drive and is set to, for example, 10 to 200 m/min.

The coating die Y is controlled to have a predetermined temperature by the above-described temperature control mechanism, and the coating material C in liquid state is supplied from the above-described tank to the coating die Y through the above-described tube member. By operating the above-described pressure-supply means, the coating material C from the tank is supplied under pressure to the liquid retaining chamber 21 through the coating material supply port 22. The coating material C that has been supplied under pressure to the liquid retaining chamber 21 is then supplied under pressure to the coating hole portion 24 immediately below the liquid retaining chamber 21 and communicating therewith.

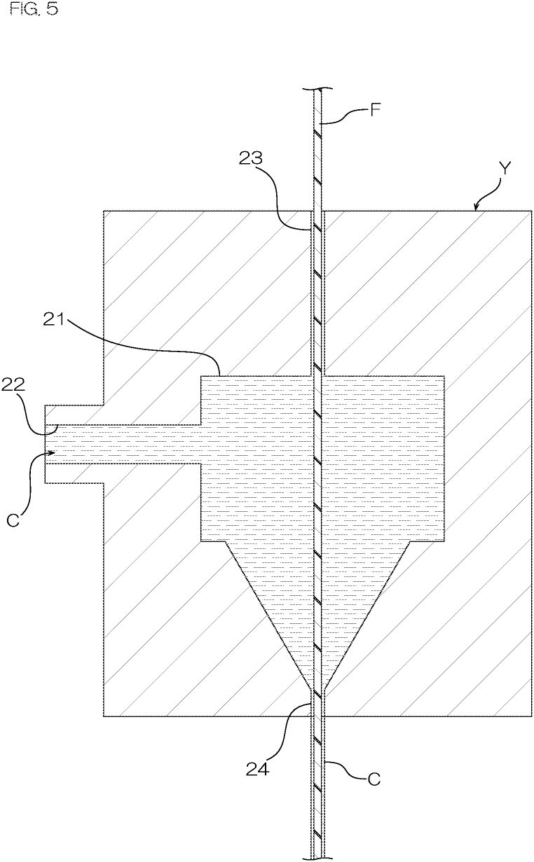

In this production method, in the coating die Y, while the coating material C in the liquid retaining chamber 21 is supplied under pressure to the coating hole portion 24, the optical fiber F is sequentially passed through the insertion hole portion 23, the liquid retaining chamber 21, and the coating hole portion 24 as shown in FIG. 5, thereby coating the circumferential side surface of the optical fiber F with the coating material C. This coating is performed under a condition that a pressure difference ΔP (MPa) between a liquid pressure of the coating material C in the liquid retaining chamber 21 and a pressure outside the coating die Y, a viscosity µ (Pa·s) of the coating material C in the liquid retaining chamber 21, and the length L (mm) of the coating hole portion 24 in the extending direction satisfy the following equation (1). That is, while the state where the following equation (1) is satisfied is maintained, continuous coating is performed on the optical fiber F with the coating die Y. In this production method, the ΔP/µL value is 0.15 or less, preferably 0.1 or less, more preferably 0.08 or less, more preferably 0.06 or less, more preferably 0.04 or less. The ΔP/µL value is, for example, 0.01 or more.

$$Δ \text{P/} μ \text{L} \leq \text{0} \text{.15}$$

The viscosity µ of the coating material C in the liquid retaining chamber 21 is preferably 0.3 Pa·s or more, more preferably 0.5 Pa·s or more, more preferably 1 Pa·s or more. The viscosity µ is, for example, 3 Pa·s or less. The viscosity µ of the coating material C in the liquid retaining chamber 21 can be adjusted, for example, by controlling the temperature of the coating die Y.

The above-mentioned pressure difference ΔP is preferably 0.3 MPa or less, more preferably 0.2 MPa or less, more preferably 0.15 MPa or less, more preferably 0.1 MPa or less. The pressure difference ΔP is, for example, 0.001 MPa or more. The pressure difference ΔP can be adjusted by controlling the supply pressure of the coating material C to the coating die Y by the above-described pressure-supply means of the coating material C.

The optical fiber F that has passed through the coating die Y to be coated with the coating material C then passes through the curing unit 12. In the curing unit 12, the coating material C on the optical fiber F is cured. When an ultraviolet curing resin composition is used as the coating material C, the curing unit 12 is an ultraviolet irradiation device, and the coating material C is cured by ultraviolet irradiation. When a thermosetting resin composition is used as the coating material C, the curing unit 12 is a heating furnace, and the coating material C is cured by heating. By passing the optical fiber F through the curing unit 12, a film of the coating material C is formed on the circumferential side surface of the optical fiber F.

After passing through the curing unit 12, the optical fiber F goes through the capstan 13 and is then wound up by the winding unit 14.

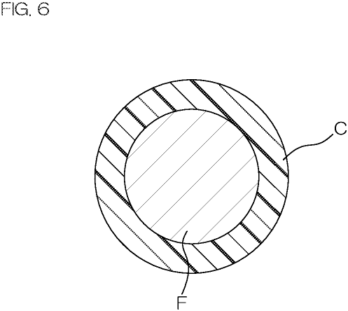

In the manner described above, the optical fiber F having its circumferential side surface coated with the cured coating material C, that is a coated optical fiber, is produced. FIG. 6 shows a cross section of the optical fiber F having the film of the coating material C formed on its circumferential side surface. The film has a thickness of, for example, 1 to 2000 µm.

In this production method, as described above, in the state where the pressure difference ΔP (MPa) between the liquid pressure of the coating material C in the liquid retaining chamber 21 and the pressure outside the coating die Y, the viscosity µ (Pa·s) of the coating material C, and the length L (mm) of the coating hole portion 24 in the extending direction satisfy the above-mentioned conditional equation (1), while the coating material C in the liquid retaining chamber 21 is supplied under pressure to the coating hole portion 24, the optical fiber F is sequentially passed through the insertion hole portion 23, the liquid retaining chamber 21, and the coating hole portion 24, thereby coating the circumferential side surface of the optical fiber F with the coating material C. The ΔP/µL value is preferably 0.1 or less, more preferably 0.08 or less, more preferably 0.06 or less, more preferably 0.04 or less.

The present inventors have found that this configuration is suitable for suppressing variations in thickness of the film along the fiber extending direction, where the film is formed by coating the circumferential side surface of the optical fiber F with the coating material C. It is considered that the configuration of the production method such that the ΔP/µL value is 0.15 or less is suitable for suppressing the above-described pulsations (slight pulsations generated during passage of the coating material C in the coating hole portion 24) in the coating material C that passes through the coating hole portion 24 together with the optical fiber F. As the pulsations are suppressed, the variations, along the fiber extending direction, in thickness of the film of the coating material C formed on the circumferential side surface of the optical fiber F are suppressed.

In the production method, the viscosity µ of the coating material C in the liquid retaining chamber 21 is preferably 0.3 Pa·s or more, more preferably 0.5 Pa·s or more, more preferably 1 Pa·s or more, as described above. This configuration is suitable for reducing the effect of the above-mentioned pressure difference ΔP (a factor in which a larger pressure difference is likely to induce the above-described pulsations of the coating material C) on the coating material C that passes through the coating hole portion 24 together with the optical fiber F, and is therefore suitable for suppressing the pulsations of the coating material C that passes through the coating hole portion 24 to thereby suppress the above-described variations in film thickness of the optical fiber.

The pressure difference ΔP in the production method is preferably 0.3 MPa or less, more preferably 0.2 MPa or less, more preferably 0.15 MPa or less, more preferably 0.1 MPa or less, as described above. This configuration is suitable for suppressing the pulsations of the coating material C that passes through the coating hole portion 24 together with the optical fiber F, and is therefore suitable for suppressing the above-described variations in film thickness of the optical fiber.

The coating hole portion 24 in the coating die Y has a length L in the extending direction of preferably 1.5 mm or more, more preferably 2 mm or more, more preferably 3 mm or more, more preferably 3.5 mm or more, more preferably 4 mm or more, as described above. This configuration is suitable for reducing the effect of the above-mentioned pressure difference ΔP on the coating material C that passes through the coating hole portion 24 together with the optical fiber F, and is therefore suitable for suppressing the pulsations of the coating material C that passes through the coating hole portion 24 to thereby suppress the above-described variations in film thickness of the optical fiber.

### EXAMPLE

### Example 1

Using the coated optical fiber production apparatus X having the configuration shown in FIG. 1, a film of the coating material C was formed on the circumferential side surface of the optical fiber F. Specifically, the optical fiber F was traveled from the feeding unit 11 to the winding unit 14 (at a traveling speed of 10 m/min), and in the coating die Y, while the coating material C in the liquid retaining chamber 21 was supplied under pressure to the coating hole portion 24, the optical fiber F was sequentially passed through the insertion hole portion 23, the liquid retaining chamber 21, and the coating hole portion 24, thereby coating the circumferential side surface of the optical fiber F with the coating material C. As the optical fiber F, an optical fiber wire having a core, a clad around the core, and an overclad around the clad was used (the core and the clad was made of acrylic polymer, and the overclad was made of polycarbonate). The optical fiber wire had an average outer diameter of 470 µm. As the coating material C in liquid state, a coating material (trade name “BESTCURE FA013”, ultraviolet curing resin composition, manufactured by T&K TOKA Corporation) having a temperature of about 40° C. was supplied under pressure to the liquid retaining chamber 21 of the coating die Y and to the coating hole portion 24 communicating therewith. In this Example, while the viscosity µ of the coating material C in the liquid retaining chamber 21 was adjusted to 0.590 Pa·s by controlling the temperature of the coating die Y to 40° C.±0.1° C., the pressure difference ΔP between the liquid pressure of the coating material C in the liquid retaining chamber 21 and the pressure outside the coating die Y was 0.05 MPa. The coating hole portion 24 of the coating die Y used in this Example had a diameter of 510 µm and a length L in the extending direction of 2 mm.

In a state where an optical fiber to be traveled in and passed through the coating die Y did not have a film of the coating material C before entering the insertion hole portion 23, an outer diameter (first outer diameter) of the optical fiber was measured at intervals of 0.1 seconds for 3 minutes, and in a state where the optical fiber had a film after going through the coating hole portion 24, an outer diameter (second outer diameter) of the optical fiber was measured at each of the points where the first outer diameter was measured at intervals of 0.1 seconds for 3 minutes. The measuring position for the first outer diameter was 150 mm upper from an upper-end inlet of the insertion hole portion 23, and the measuring position for the second outer diameter was 150 mm lower from a lower-end outlet of the coating hole portion 24. A high-precision measurement device LS9000 (manufactured by KEYENCE Corporation) was used to measure the outer diameters. Then, a coating thickness (= [second outer diameter - first outer diameter]/2) of the optical fiber was calculated at each point where both the first outer diameter and the second outer diameter were measured, and a coefficient of variation (3σ/Ave.) relating to variations in film thickness was determined from the standard deviation (σ) and the average value (Ave.) based on the coating thickness data relating to the three-minute measurement. The coefficient of variation values (%) are shown in Table 1. When the coefficient of variation was 11% or less, the variations in film thickness of the optical fiber were evaluated as “excellent”; when the coefficient of variation was more than 11% and 13% or less, the variations were evaluated as “good”; and when the coefficient of variation was more than 13%, the variations were evaluated as “bad”. The evaluations are also shown in Table 1.

### Example 2

A film of the coating material C was formed on the circumferential side surface of the optical fiber in the same method as in Example 1, except that the above-described pressure difference ΔP was 0.2 MPa instead of 0.05 MPa, and the length L in the extending direction of the coating hole portion 24 was 4 mm instead of 2 mm. Then, the outer diameters of the optical fiber before and after forming of the film were measured, and the coefficient of variation of the coating thickness was determined to evaluate variations in film thickness, in the same manner as described above regarding Example 1. The coefficient of variation and the evaluation result are shown in Table 1 (the same applies to those in Examples and Comparative Examples to be described later).

### Example 3

A film of the coating material C was formed on the circumferential side surface of the optical fiber in the same manner as in Example 1, except that the above-described pressure difference ΔP was 0.1 MPa instead of 0.05 MPa, and the viscosity µ of the coating material C in the liquid retaining chamber 21 was adjusted to 1.314 Pa·s by controlling the temperature of the coating die Y to 28° C.±0.1° C. while the temperature of the coating material C to be supplied to the coating die Y was about 28° C. Then, the outer diameters of the optical fiber before and after forming of the film were measured, and the coefficient of variation of the coating thickness was determined to evaluate variations in film thickness, in the same manner as described above regarding Example 1.

### Example 4

A film of the coating material C was formed on the circumferential side surface of the optical fiber in the same manner as in Example 1, except that the above-described pressure difference ΔP was 0.1 MPa instead of 0.05 MPa, the viscosity µ of the coating material C in the liquid retaining chamber 21 was adjusted to 1.314 Pa·s by controlling the temperature of the coating die Y to 28° C.±0.1° C. while the temperature of the coating material C to be supplied to the coating die Y was about 28° C., and the length L in the extending direction of the coating hole portion 24 was 4 mm instead of 2 mm. Then, the outer diameters of the optical fiber before and after forming of the film were measured, and the coefficient of variation of the coating thickness was determined to evaluate variations in film thickness, in the same manner as described above regarding Example 1.

### Example 5

A film of the coating material C was formed on the circumferential side surface of the optical fiber in the same manner as in Example 1, except that the above-described pressure difference ΔP was 0.1 MPa instead of 0.05 MPa, the viscosity µ of the coating material C in the liquid retaining chamber 21 was adjusted to 0.319 Pa·s by controlling the temperature of the coating die Y to 50° C.±0.1° C. while the temperature of the coating material C to be supplied to the coating die Y was about 50° C., and the length L in the extending direction of the coating hole portion 24 was 4 mm instead of 2 mm. Then, the outer diameters of the optical fiber before and after forming of the film were measured, and the coefficient of variation of the coating thickness was determined to evaluate variations in film thickness, in the same manner as described above regarding Example 1 s.

### Example 6

A film of the coating material C was formed on the circumferential side surface of the optical fiber in the same manner as in Example 1, except that the above-described pressure difference ΔP was 0.1 MPa instead of 0.05 MPa, and the length L in the extending direction of the coating hole portion 24 was 7 mm instead of 2 mm. Then, the outer diameters of the optical fiber before and after forming of the film were measured, and the coefficient of variation of the coating thickness was determined to evaluate variations in film thickness, in the same manner as described above regarding Example 1.

### Comparative Example 1

A film of the coating material C was formed on the circumferential side surface of the optical fiber in the same manner as in Example 1, except that the above-described pressure difference ΔP was 0.2 MPa instead of 0.05 MPa. Then, the outer diameters of the optical fiber before and after forming of the film were measured, and the coefficient of variation of the coating thickness was determined to evaluate variations in film thickness, in the same manner as described above regarding Example 1.

### Comparative Example 2

A film of the coating material C was formed on the circumferential side surface of the optical fiber in the same manner as in Example 1, except that the above-described pressure difference ΔP was 0.1 MPa instead of 0.05 MPa, and the viscosity µ of the coating material C in the liquid retaining chamber 21 was adjusted to 0.319 Pa·s by controlling the temperature of the coating die Y to 50° C.±0.1° C. while the temperature of the coating material C to be supplied to the coating die Y was about 50° C. Then, the outer diameters of the optical fiber before and after forming of the film were measured, and the coefficient of variation of the coating thickness was determined to evaluate variations in film thickness, in the same manner as described above regarding Example 1.

### Evaluation

For example, as seen in the difference between the coefficients of variation in Example 1 and Comparative Example 1, it was found that the smaller the above-mentioned pressure difference ΔP was, the smaller the variations in film thickness tended to be. As seen in the difference between the coefficients of variation in Example 3 and Comparative Example 2, and the difference between the coefficients of variation in Examples 4 and 5, it was found that the larger the above-mentioned viscosity µ was, the smaller the variations in film thickness tended to be. As seen in the difference between the coefficients of variation in Example 2 and Comparative Example 1, the difference between the coefficients of variation in Examples 3 and 4, and the difference between the coefficients of variation in Example 5 and Comparative Example 2, it was found that the larger the above-mentioned length L was, the smaller the variations in film thickness tended to be. When the ΔP/µL value was 0.15 or less (Examples 1 to 6), the coefficient of variation was suppressed to 13% or less, and when the ΔP/µL value was 0.04 or less (Examples 3, 4, and 6), the coefficient of variation was particularly suppressed to 11% or less.

TABLE 1

| | Pressure difference ΔP (MPa) | Viscosity µ (Pa•s) | Length L (mm) | ΔP/µL | 3σ/Ave. (%) | Evaluation |
|---|---|---|---|---|---|---|
| Example 1 | 0.05 | 0.590 | 2 | 0.042 | 12.2 | Good |
| Example 2 | 0.2 | 0.590 | 4 | 0.085 | 12.3 | Good |
| Example 3 | 0.1 | 1.314 | 2 | 0.038 | 11.0 | Excellent |
| Example 4 | 0.1 | 1.314 | 4 | 0.019 | 10.0 | Excellent |
| Example 5 | 0.1 | 0.319 | 4 | 0.078 | 11.1 | Good |
| Example 6 | 0.1 | 0.590 | 7 | 0.024 | 10.6 | Excellent |
| Comparative Example 1 | 0.2 | 0.590 | 2 | 0.170 | 15.1 | Bad |
| Comparative Example 2 | 0.1 | 0.319 | 2 | 0.157 | 13.2 | Bad |

### Industrial Applicability

The present invention can be employed for producing an optical fiber having a film formed on its surface.

### Description of Reference Numerals

X coated optical fiber production apparatus
F optical fiber
C coating material
11 feeding unit
12 curing unit
13 capstan
14 winding unit
Y coating die
21 liquid retaining chamber
22 coating material supply port
23 insertion hole portion
24 coating hole portion

1. A method for producing a coated optical fiber using a coating die, the coating die comprising:
a liquid retaining chamber that receives a coating material in liquid state;
an insertion hole portion that communicates with the liquid retaining chamber; and
a coating hole portion that communicates with the liquid retaining chamber, the coating hole portion being opposed to the insertion hole portion via the liquid retaining chamber and extending in a direction away from the liquid retaining chamber,
the method comprising coating a circumferential side surface of an optical fiber with the coating material by, in the coating die, passing the optical fiber sequentially through the insertion hole portion, the liquid retaining chamber, and the coating hole portion while the coating material in the liquid retaining chamber is supplied under pressure to the coating hole portion,
wherein a pressure difference ΔP (MPa) between a liquid pressure of the coating material in the liquid retaining chamber and a pressure outside the coating die, a viscosity µ (Pa·s) of the coating material in the liquid retaining chamber, and a length L (mm) of the coating hole portion in an extending direction satisfy a relationship of ΔP/µL ≤ 0.15.

2. The method for producing a coated optical fiber according to claim 1, wherein the length L is 1.5 mm or more.

3. The method for producing a coated optical fiber according to claim 1, wherein the viscosity µ is 0.3 Pa·s or more.

4. The method for producing a coated optical fiber according to claim 1, wherein the pressure difference ΔP is 0.3 MPa or less.

5. The method for producing a coated optical fiber according to claim 1, wherein the coating material is an ultraviolet curing resin composition.

6. A coated optical fiber production apparatus used in the method for producing a coated optical fiber according to claim 1, comprising a coating die comprising:
a liquid retaining chamber for receiving a coating material in liquid state;
an insertion hole portion that communicates with the liquid retaining chamber; and
a coating hole portion that communicates with the liquid retaining chamber, the coating hole portion being opposed to the insertion hole portion via the liquid retaining chamber and extending in a direction away from the liquid retaining chamber.

7. The coated optical fiber production apparatus according to claim 6, wherein the coating hole portion has a length L in an extending direction of 1.5 mm or more.
